(19) United States
(12) Patent Application Publication
(10) Pub. No.: US 2007/0253120 A1
(43) Pub. Date: Nov. 1, 2007

(54) MAGNETORESISTIVE EFFECT ELEMENT AND MAGNETIC MEMORY

(75) Inventors: Yoshiaki Saito, Kawasaki-Shi (JP); Hideyuki Sugiyama, Yokohama-Shi (JP); Tomoaki Inokuchi, Kawasaki-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/737,379

(22) Filed: Apr. 19, 2007

(30) Foreign Application Priority Data
Apr. 28, 2006 (JP) 2006-126682
Sep. 8, 2006 (JP) 2006-244881

(51) Int. Cl. G11B 5/33

(52) U.S. Cl. 360/324.11

(57) ABSTRACT

It is possible to provide a magnetoresistive effect element which has thermal stability even if it is made fine and in which the magnetization in the magnetic recording layer can be inverted at a low current density. A magnetoresistive effect element includes: a magnetization pinned layer having a magnetization pinned in a direction; a magnetization free layer of which magnetization direction is changeable by injecting spin-polarized electrons into the magnetization free layer; a tunnel barrier layer provided between the magnetization pinned layer and the magnetization free layer; a first antiferromagnetic layer provided on the opposite side of the magnetization pinned layer from the tunnel barrier layer; and a second antiferromagnetic layer which is provided on the opposite side of the magnetization free layer from the tunnel barrier layer and which is thinner in thickness than the first antiferromagnetic layer.

### CROSS-REFERENCE TO RELATED APPLICATION

This application is based upon and claims the benefit of priority from prior Japanese Patent Application Nos. 2006-126682 and 2006-244881, filed on Apr. 28, 2006 and Sep. 8, 2006 in Japan, the entire contents of which are incorporated herein by reference.

### FIELD OF THE INVENTION

The present invention relates to a magnetoresistive effect element and a magnetic memory.

### RELATED ART

Magnetoresistive effect elements using magnetic substance films are used in, for example, magnetic heads and magnetic sensors. In addition, it is proposed to use the magnetoresistive effect elements in solid state magnetic memories (magnetoresistive effect memories: MRAMs (Magnetic Random Access Memories)).

In the MRAM, a TMR (Tunneling Magneto-Resistance effect) element having a tunnel barrier layer interposed between two ferromagnetic layers, one of which serves as a magnetic recording layer and the other of which serves as a magnetization pinned layer, is used as a storage element. This MRAM is attracting attention as a fast nonvolatile random access memory. However, the MRAM has a problem that the value of the write current is large with a writing method using a magnetic field caused by current and a larger capacity cannot be implemented.

To solve this problem, a writing method using the spin injection method is proposed (see, for example, U.S. Pat. No. 6,256,223). This spin injection method utilizes the fact that the direction of the magnetization in the magnetic recording layer is inverted by injecting spin-polarized electrons into the magnetic recording layer of the storage element.

When the spin injection method is applied to the TMR element, however, there is a problem of element destruction such as dielectric breakdown of the tunnel barrier layer and there is a problem in element reliability. As for the final goal, it is necessary to implement a structure in which the magnetization direction of the magnetic recording layer can be inverted at a low current density without being subjected to the influence of thermal fluctuation when the structure is made fine in order to ensure scalability.

### SUMMARY OF THE INVENTION

The present invention has been made in view of these circumstances, and an object thereof is to provide a magnetoresistive effect element which has thermal stability even if it is made fine and in which the magnetization in the magnetic recording layer can be inverted at a low current density, and provide a magnetic memory using such a magnetoresistive effect element.

A magnetoresistive effect element according to a first aspect of the present invention includes: a magnetization pinned layer having a magnetization pinned in a direction; a magnetization free layer of which magnetization direction is changeable by injecting spin-polarized electrons into the magnetization free layer; a tunnel barrier layer provided between the magnetization pinned layer and the magnetization free layer; a first antiferromagnetic layer provided on the opposite side of the magnetization pinned layer from the tunnel barrier layer; and a second antiferromagnetic layer which is provided on the opposite side of the magnetization free layer from the tunnel barrier layer and which is thinner in thickness than the first antiferromagnetic layer.

A magnetic memory according to a second aspect of the present invention includes: a memory cell comprising the magnetoresistive effect element described above; a first wiring to which one of ends of the magnetoresistive effect element is electrically connected; and a second wiring to which the other of the ends of the magnetoresistive effect element is electrically connected.

A magnetic memory according to a third aspect of the present invention includes: a memory cell comprising first and second magnetoresistive effect elements described above; a first wiring connected electrically to first ends of the first and second magnetoresistive effect elements; a second wiring connected electrically to a second end of the first magnetoresistive effect element; and a third wiring connected electrically to a second end of the second magnetoresistive effect element, wherein a layer arrangement of the first magnetoresistive effect element in a direction directed from the first wiring to the second wiring is reverse of a layer arrangement of the second magnetoresistive effect element in a direction directed from the first wiring to the third wiring.

### BRIEF DESCRIPTION OF THE DRAWINGS

FIG. 1 is a sectional view showing a magnetoresistive effect element according to a first embodiment;

FIG. 2 is a diagram showing dependence of a magnetization curve of a stacked film including a magnetization free layer and an antiferromagnetic layer upon a film thickness of the antiferromagnetic layer;

FIG. 3 is a diagram showing dependence of spin torque strength upon a relative angle between the magnetization layer and a magnetization pinned layer;

FIG. 4 is a sectional view showing a magnetoresistive effect element according to a first modification of the first embodiment;

FIG. 5 is a sectional view showing a magnetoresistive effect element according to a second modification of the first embodiment;

FIG. 6 is a sectional view showing a magnetoresistive effect element according to a third modification of the first embodiment;

FIG. 7 is a sectional view showing a magnetic memory according to a second embodiment;

FIGS. 8(a) and 8(b) are diagrams showing a magnetoresistive effect element used in a magnetic memory according to a second embodiment;

FIG. 9 is a sectional view showing a magnetic memory according to a modification of the second embodiment;

FIGS. 10(a) and 10(b) are diagrams showing a magnetoresistive effect element used in a magnetic memory according to the modification of the second embodiment;

FIG. 11 is a sectional view showing a magnetic memory according to a third embodiment;

FIG. 12 is a diagram showing relations between a current density and resistance of a sample 1 of a magnetoresistive effect element according to a first example;

FIG. 13 is a diagram showing relations between the current density and resistance of a sample 2 of a magnetoresistive effect element according to the first example;

FIG. 14 is a diagram showing relations between an inclination angle θ and a current density of samples 3 and 4 of a magnetoresistive effect element according to a second example; and

FIG. 15 is a sectional view showing a magnetic memory according to a fourth embodiment.

### DETAILED DESCRIPTION OF THE INVENTION

Hereafter, embodiments of the present invention will be described with reference to the drawings.

### First Embodiment

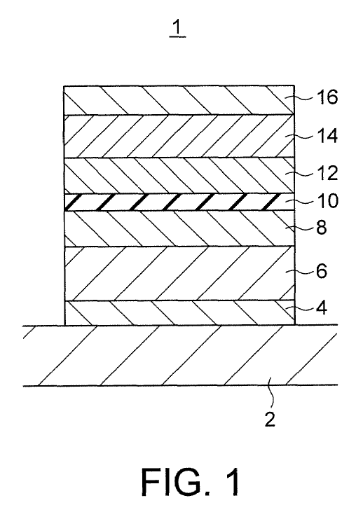

A section of a magnetoresistive effect element according to a first embodiment of the present invention is shown in FIG. 1. The magnetoresistive effect element 1 according to this embodiment is a magnetoresistive effect element of bottom pin type. The magnetoresistive effect element 1 includes an underlying layer 4 provided on a lower electrode 2, an antiferromagnetic layer 6 provided on the underlying layer 4, a magnetization pinned layer 8 including a ferromagnetic layer provided on the antiferromagnetic layer 6 and pinned in magnetization, a tunnel barrier layer 10 provided on the magnetization pinned layer 8, a magnetization free layer (magnetic recording layer) 12 including a ferromagnetic layer which is provided on the tunnel barrier layer 10 and which has a variable direction of magnetization, an antiferromagnetic layer 14 provided on the magnetization free layer 12, a cap layer 16 provided on the antiferromagnetic layer 14, and an upper electrode (not illustrated) provided on the cap layer 16. In the present embodiment, the magnetoresistive effect element 1 has a structure in which the antiferromagnetic layer 14 adjacent to the magnetization free layer 12 is thinner in film thickness than the antiferromagnetic layer 6 adjacent to the magnetization pinned layer 8.

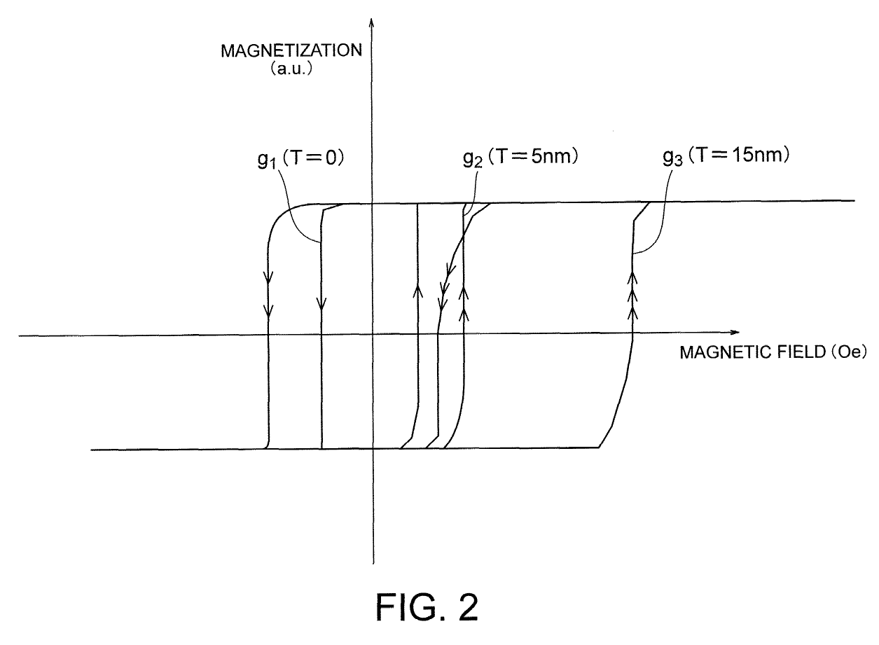

Magnetization curves obtained when the film thickness of the ferromagnetic layer is made constant in the stacked film formed of a ferromagnetic layer and an antiferromagnetic layer and the film thickness T of the antiferromagnetic layer is set equal to 0 nm, 5 nm and 15 nm are represented by graphs g₁, g₂ and g₃ in FIG. 2, respectively. When the film thickness T of the antiferromagnetic layer is thick (T=15 nm), unidirectional anisotropy occurs. When the film thickness T is thin (T=5 nm), unidirectional anisotropy does not occur, but it is appreciated that the coercive force increases as compared with the case where the antiferromagnetic layer is not present (T=0 nm). The increase of the coercive force means that the thermal stability is improved even if the structure is made fine.

In the magnetoresistive effect element 1 according to the present embodiment, the ferromagnetic layer 14 adjacent to the magnetization free layer 12 is made thinner in thickness than the antiferromagnetic layer 6 adjacent to the magnetization pinned layer 8. Therefore, the magnetization direction of the magnetization pinned layer 8 is provided with the unidirectional anisotropy by the antiferromagnetic layer 6, and the magnetization direction of the magnetization free layer 12 is provided with the unidirectional anisotropy by the antiferromagnetic layer 14. Thus, the thermal stability is improved.

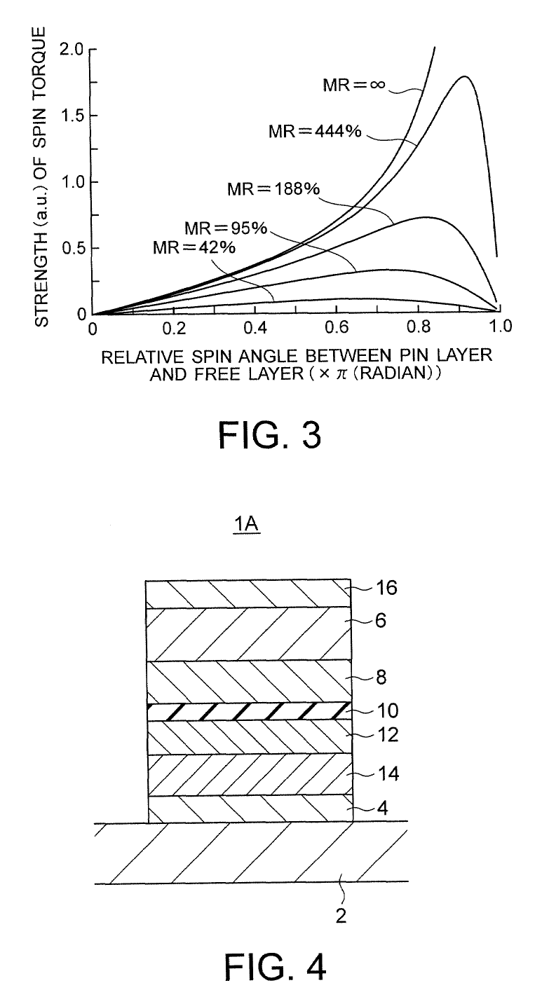

In the present embodiment, the antiferromagnetic layer 6 is provided so as to be adjacent to the magnetization pinned layer 8, and the antiferromagnetic layer 14 is provided so as to be adjacent to the magnetization free layer 12. As a result, an angle (relative angle) formed between the direction of magnetization (spin) of the magnetization pinned layer 8 and that of the magnetization free layer 12 can be varied to 0 degree or 180 degrees. If the relative angle of magnetization (spin) is varied to 0 degree or 180 degrees, the spin injection inversion efficiency, i.e., the MR ratio at the time of writing rises as shown in FIG. 3. The abscissa in FIG. 3 indicates the normalized relative angle between the spin in the magnetization pinned layer and that in the magnetization free layer. In other words, the value “0” on the abscissa corresponds to 0 degrees and the value “1.0” corresponds to 180 degree. As evident from FIG. 3, it is desirable that the angle θ formed between the magnetic moment (magnetization) of the ferromagnetic layer (magnetization pinned layer) 8 pinned by the antiferromagnetic layer 6 having a thick thickness and the magnetic moment (magnetization) of the ferromagnetic layer (magnetization free layer) 12 pinned by the antiferromagnetic layer 14 having a thin thickness is in the range greater than 0.75 and less than 1 in the value on the abscissa, i.e., in the range of 135≦θ<180 degrees. If magnetization inversion is caused by spin injection, the angle θ formed by the magnetization direction in the magnetization pinned layer with the magnetization direction in the magnetization free layer changes from θ to an angle near (180°-θ). If magnetization inversion is further caused, then the angle changes from an angle near (180°-θ) to an angle near θ. Therefore, it is desirable that the angle formed by the magnetization direction in the magnetization pinned layer with the magnetization direction in the magnetization free layer is in the range of 135≦θ<180 or in the range of 0<θ≦45. Therefore, an easy axis of the magnetization in the magnetization pinned layer and an easy axis of the magnetization in the magnetization free layer form an angle which is greater than 0 degree and which is 45 degrees or less. The easy axis of the magnetization means a magnetization direction in absence of external magnetic field. Since this angle θ is a relative angle, it doesn't matter whether the magnetization direction of the magnetization free layer is in the clockwise direction or in the counterclockwise direction with reference to the magnetization direction of the magnetization pinned layer 8, as long as the magnetization direction is in the above-described range.

As a method for tilting the magnetic moment (spin moment), it is most desirable to select materials of the antiferromagnetic layers 6 and 14 so as to make them different from each other. It is possible to use NiMn, PtMn or IrMn as the thick antiferromagnetic layer 6 and use FeMn, IrMn or PtMn as the thin antiferromagnetic layer 14.

If the materials of the antiferromagnetic layers are made different, the blocking temperature can be changed. For example, PtMn is used as the thick antiferromagnetic layer 6 and FeMn is used as the thin antiferromagnetic layer 14. The blocking temperature of PtMn is approximately 320° C. and the blocking temperature of FeMn is approximately 200° C. Since the blocking temperatures are thus different, magnetization in the magnetization pinned layer 8 is first pinned at 320° C. or below on the way of the temperature fall in annealing in the magnetic field. At a temperature of 250° C. or below with the magnetization pinned layer 8 pinned sufficiently, an applied magnetic field is tilted in a direction of a desired angle in which the magnetization in the magnetization free layer 12 is desired to be tilted. As for the angle, it is desirable that the angle of the magnetic moment of the ferromagnetic layer 12 pinned by the antiferromagnetic layer 14 having a thin thickness is tilted from the magnetization pinned layer 8 by 0<θ≦45 degrees. The antiferromagnetic layer 14 formed of FeMn adjacent to the magnetization free layer 12 is provided with not the unidirectional anisotropy but uniaxial anisotropy having heat resistance, if the thickness is made thin. As for the combination of the antiferromagnetic layers, there are a pair of NiMn and IrMn or FeMn, a pair of PtMn and IrMn or FeMn, and a pair of IrMn and FeMn. Besides, however, there are several examples. Any combination of antiferromagnetic substances differing in blocking temperature may be used. Even if the same antiferromagnetic material is used, the blocking temperature can be changed by changing the thickness of the antiferromagnetic layer.

The present inventors have found that if FeMn is used in the thin antiferromagnetic layer 14 the spin reflection term increases and the damping constant term decreases and consequently the spin injection magnetization inversion can be implemented at a smaller current density as described later with reference to a second embodiment. Even if Ir—Mn is used, the spin reflection term increases, advantageously resulting in a lower current density.

When causing spin inversion in the magnetoresistive effect element according to the present embodiment from a state in which the magnetization direction of the magnetization free layer 12 forms an angle which is greater than 0 degree and which is 45 degrees or less with the magnetization direction of the magnetization pinned layer 8 (hereafter referred to as parallel magnetization direction state as well) to a state in which the magnetization direction of the magnetization free layer 12 forms relatively an angle which is 135 degrees or more and which is 180 degrees or less with the magnetization direction of the magnetization pinned layer 8 (hereafter referred to as antiparallel magnetization direction state as well), spin-polarized electrons are injected from the magnetization free layer 12 side. In other words, a current is let flow from the magnetization pinned layer 8 side to the magnetization free layer 12.

On the other hand, when causing spin inversion from the state in which the magnetization direction of the magnetization free layer 12 is antiparallel to the magnetization direction of the magnetization pinned layer 8 to the parallel state, spin-polarized electrons are injected from the magnetization pinned layer 8 side. In other words, a current is let flow from the magnetization free layer 12 side to the magnetization pinned layer 8.

The magnetoresistive effect element 1 according to the present embodiment is bottom pin type. Alternatively, a top pin type magnetoresistive effect element 1A may be used in a first modification of the present embodiment shown in FIG. 4. In the top pin type magnetoresistive effect element 1A, the underlying layer 4 is provided on the lower electrode 2. The antiferromagnetic layer 14 is provided on the underlying layer 4. The magnetization free layer (magnetic recording layer) 12 is provided on the antiferromagnetic layer 14. The tunnel barrier layer 10 is provided on the magnetization free layer 12. The magnetization pinned layer 8 is provided on the tunnel barrier layer 10. The antiferromagnetic layer 6 is provided on the magnetization pinned layer 8. The cap layer 16 is provided on the antiferromagnetic layer 6. An upper electrode (not illustrated) is provided on the cap layer 16.

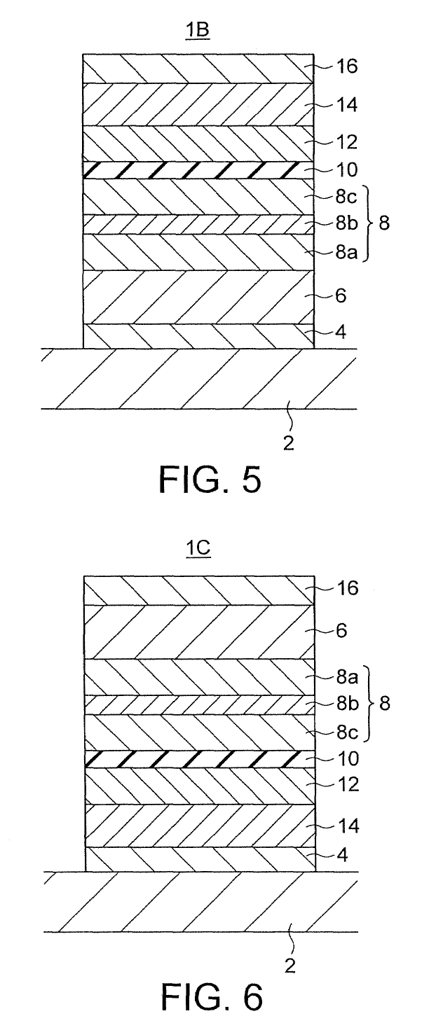

A magnetoresistive effect element 1B according to a second modification of the present embodiment is shown in FIG. 5. The magnetoresistive effect element 1B according to the second modification is obtained by replacing the magnetization pinned layer 8 in the bottom pin type magnetoresistive effect element 1 according to the present embodiment shown in FIG. 1 with a stacked film of a magnetic layer 8a/a nonmagnetic layer 8b/a magnetic layer 8c, i.e., a synthetic structure. By thus providing the magnetization pinned layer 8 with the synthetic structure, preferably stability of the magnetization increases.

A magnetoresistive effect element 1C according to a third modification of the present embodiment is shown in FIG. 6. The magnetoresistive effect element 1C according to the third modification is obtained by replacing the magnetization pinned layer 8 in the top pin type magnetoresistive effect element 1A according to the second modification shown in FIG. 4 with a stacked film of a synthetic structure, i.e., a stacked film of a magnetic layer 8a/a nonmagnetic layer 8b/a magnetic layer 8c. In the magnetoresistive effect element 1C according to the third modification as well, stability of the magnetization increases in the same way as the second modification.

In the first to third modifications according to the present embodiment as well, the thermal stability is improved and it becomes possible to make the spin inversion efficiency large even if the structure is made fine in the same way as the present embodiment.

In the present embodiment and its modifications, the magnetic layer (ferromagnetic layer) of the magnetoresistive effect element is formed of a thin film of at least one kind or a multi-layer film of them selected from a group including a Ni—Fe alloy, a Co—Fe alloy, a Co—Fe—Ni alloy, a (Co, Fe, Ni)—(Si, B) alloy, a (Co, Fe, Ni)—(B)—(P, Al, Mo, Nb, Mn) or an amorphous material such as a Co—(Zr, Hf, Nb, Ta, Ti) film, and a Heusler alloy such as Co—Cr—Fe—Al, Co—Cr—Fe—Si, Co—Mn—Si and Co—Mn—Al. Expression (,) means that at least one of elements in ( ) is contained.

In the present embodiment and its modifications, it is desirable that the magnetization pinned layer is a ferromagnetic layer having a unidirectional anisotropy and the magnetization free layer (magnetic recording layer) is a ferromagnetic layer having a uniaxial anisotropy. Its thickness is desirable to be in the range of 0.1 nm to 100 nm inclusive. In addition, it is necessary that the ferromagnetic layer has such a thickness as to prevent super-paramagnetism and it is more desirable that the ferromagnetic layer has a thickness of 0.4 nm or more.

It is possible to adjust magnetic characteristics and adjust various physical properties such as the crystal property, mechanical characteristics, and chemical characteristics by adding non-magnetic elements such as Ag (silver), Cu (copper), Au (gold), Al (aluminum), Mg (magnesium), Si (silicon), Bi (bismuth), Ta (tantalum), B (boron), C (carbon), O (oxygen), N (nitrogen), Pd (palladium), Pt (platinum), Zr (zirconium), Ir (iridium), W (tungsten), Mo (molybdenum), and Nb (niobium) to these magnetic substances forming the ferromagnetic layer.

Specifically, as a method for pinning the magnetic layer in one direction, a stacked film having a three-layer structure is used. As the stacked film having a three-layer structure, for example, Co(Co—Fe)/Ru (ruthenium)/Co(Co—Fe), Co(Co—Fe)/Ir (iridium)/Co(Co—Fe), Co(Co—Fe)/Os (osmium)/Co(Co—Fe), Co(Co—Fe)/Re (rhenium)/Co(Co—Fe), an amorphous material layer of Co—Fe—B or the like/Ru (ruthenium)/an amorphous material layer of Co—Fe—B or the like, an amorphous material layer of Co—Fe—B or the like/Ir (iridium)/an amorphous material layer of Co—Fe—B or the like, an amorphous material layer of Co—Fe—B or the like/Os (osmium)/an amorphous material layer of Co—Fe—B or the like, an amorphous material layer of Co—Fe—B or the like/Re (rhenium)/an amorphous material layer of Co—Fe—B or the like, an amorphous material layer of Co—Fe—B or the like/Ru (ruthenium)/Co—Fe or the like, an amorphous material layer of Co—Fe—B or the like/Ir (iridium)/Co—Fe, an amorphous material layer of Co—Fe—B or the like/Os (osmium)/Co—Fe, or an amorphous material layer of Co—Fe—B or the like/Re (rhenium)/Co—Fe or the like is used. When these stacked films are used as the magnetization pinned layer, it is desirable to provide an antiferromagnetic layer adjacent to the magnetization pinned layer. As the antiferromagnetic film in this case as well, Fe—Mn, Pt—Mn, Pt—Cr—Mn, Ni—Mn, Ir—Mn, NiO, Fe₂O₃ or the like can be used in the same way as the foregoing description. If this structure is used, a stray field from the magnetization pinned layer can be weakened (or adjusted). And the magnetization shift of the magnetization free layer (magnetic recording layer) can be adjusted by changing the thickness of the two ferromagnetic layers that form the magnetization pinned layer.

As the magnetic recording layer, a two-layer structure represented as a soft magnetic layer/ferromagnetic layer or a three-layer structure represented as a ferromagnetic layer/a soft magnetic layer/a ferromagnetic layer may also be used. As the magnetic recording layer, a three-layer structure represented as a ferromagnetic layer/a non-magnetic layer/a ferromagnetic layer or a five-layer structure represented as a ferromagnetic layer/a non-magnetic layer/a ferromagnetic layer/a non-magnetic layer/a ferromagnetic layer may be used. At this time, it doesn't matter if the kind and film thickness of the ferromagnetic layer are changed.

In particular, if Co—Fe, Co—Fe—Ni, or Fe rich Ni—Fe having a large MR is used in the ferromagnetic layer located near the insulation barrier and Ni rich Ni—Fe, Ni rich Ni—Fe—Co or the like is used in the ferromagnetic layer that is not-in contact with the tunnel barrier layer, then the switching magnetic field can be weakened while keeping the MR at a large value. It is more favorable. As the non-magnetic material, Ag (silver), Cu (copper), Au (gold), Al (aluminum), Ru (ruthenium), Os (osmium), Re (rhenium), Si (silicon), Bi (bismuth), Ta (tantalum), B (boron), C (carbon), Pd (palladium), Pt (platinum), Zr (zirconium), Ir (iridium), W (tungsten), Mo (molybdenum), Nb (niobium), or their alloy can be used.

In the magnetic recording layer as well, it is possible to adjust magnetic characteristics and adjust various physical properties such as the crystal property, mechanical characteristics, and chemical characteristics by adding non-magnetic elements such as Ag (silver), Cu (copper), Au (gold), Al (aluminum), Ru (ruthenium), Os (osmium), Re (rhenium), Mg (magnesium), Si (silicon), Bi (bismuth), Ta (tantalum), B (boron), C (carbon), O (oxygen), N (nitrogen), Pd (palladium), Pt (platinum), Zr (zirconium), Ir (iridium), W (tungsten), Mo (molybdenum), and Nb (niobium) to the magnetic substances forming the magnetic recording layer.

When a TMR element is used as the magnetoresistive effect element, it is possible to use various insulators (dielectrics) such as Al₂O₃ (aluminum oxide), SiO₂ (silicon oxide), MgO (magnesium oxide), AlN (aluminum nitride), Bi₂O₃ (bismuth oxide), MgF₂ (magnesium fluoride), CaF₂ (calcium fluoride), SrTiO₂ (titanium oxide strontium), AlLaO₃ (lanthanum oxide aluminum) and Al—N—O (aluminum oxide nitride), as the tunnel barrier layer (or dielectric layer) provided between the magnetization pinned layer and the magnetic recording layer.

It is not necessary that these compounds have a completely accurate composition from the view of stoichiometry. Loss, excess, or insufficiency of oxygen, nitrogen, fluorine or the like may exist. It is desirable that the thickness of the insulation layer (dielectric layer) is thin to the extent that the tunnel current flows. As a matter of fact, it is desirable that the thickness is 10 nm or less.

Such a magnetoresistive effect element can be formed on a predetermined substrate by using ordinary thin film forming means such as various sputtering methods, the evaporation method, or the molecular beam epitaxy method. As the substrate in this case, various substrates such as Si (silicon), SiO₂ (silicon oxide), Al₂O₃ (aluminum oxide), spinel and AlN (aluminum nitride) substrates can be used.

Furthermore, a layer formed of Ta (tantalum), Ti (titanium), Pt (platinum), Pd (palladium), Au (gold), Ti (titanium)/Pt (platinum), Ta (tantalum)/Pt (platinum), Ti (titanium)/Pd (palladium), Ta (tantalum)/Pd (palladium), Cu (copper), Al (aluminum), Cu (copper), Ru (ruthenium), Ir (iridium), or Os (osmium) may be provided on the substrate as the underlying layer, protection layer or hard mask.

### Second Embodiment

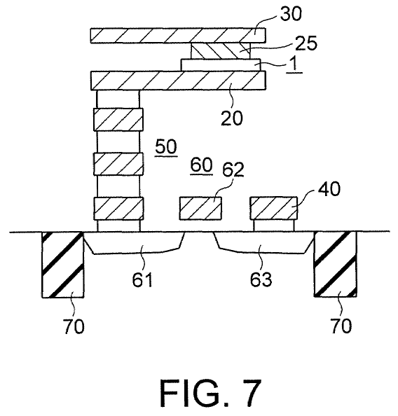

A magnetic memory according to a second embodiment of the present invention is shown in FIG. 7. The magnetic memory according to this embodiment includes at least one memory cell. This memory cell is provided in an intersection region of a bit line 30 and a word line 40. The memory cell includes the bottom pin type magnetoresistive effect element 1 according to the first embodiment shown in FIG. 1 and a selection transistor 60 for both writing and reading, and forms one bit. The selection transistor 60 includes a source region 61, a gate 62 and a drain region 63. One of terminals of the magnetoresistive effect element 1 is connected to a extraction electrode 20, and the other of the terminals is connected to the bit line 30 via a metal hard mask or via 25. The extraction electrode 20 is connected to the source region 61 of the selection transistor 60 via a connection part 50. The word line 40 is connected to the drain region 63 of the selection transistor 60. The selection transistor 60 is formed in an element region of a semiconductor substrate isolated by an element isolation region 70 formed of an insulation film.

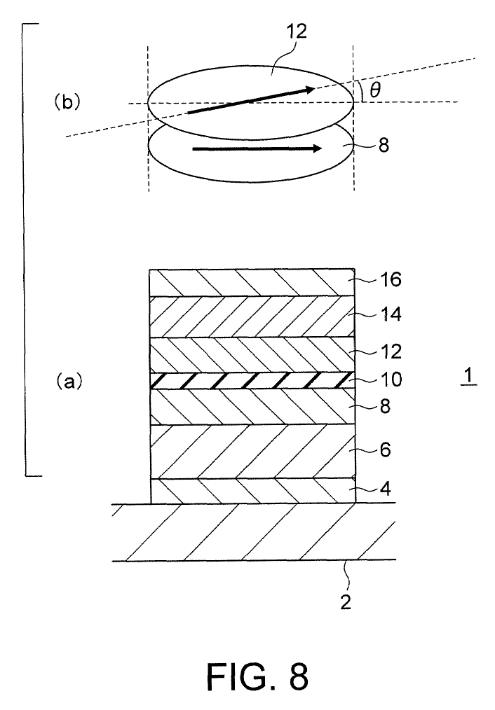

A configuration of the magnetoresistive effect element 1 used in the magnetic memory according to the present embodiment is shown in FIG. 8(a). The relation between the direction of magnetization (spin moment) in the magnetization pinned layer 8 and the direction of magnetization in the magnetic recording layer (magnetization free layer) 12 is shown in FIG. 8(b). In this magnetoresistive effect element 1, the direction of magnetization (spin moment) in the magnetization pinned layer 8 and the direction of magnetization in the magnetic recording layer (magnetization free layer) 12 form a predetermined angle θ which is greater than 0 degree and which is 45 degrees or less as shown in FIG. 8(b). As described with reference to the first embodiment, therefore, it becomes possible to make the spin inversion efficiency large. As shown in FIG. 8(b), the film surface of the magnetoresistive effect element 1 takes an elliptical shape. In this case, the direction of the magnetization (spin moment) in the magnetization pinned layer 8 is made parallel to the major axis of an ellipse. The direction of the magnetization in the magnetic recording layer (magnetization free layer) 12 is tilted from the major axis of the ellipse.

The magnetoresistive effect element 1 according to the first embodiment is used in the magnetic memory according to the present embodiment. In the same way as the first embodiment, the thermal stability can be improved even if the structure is made fine.

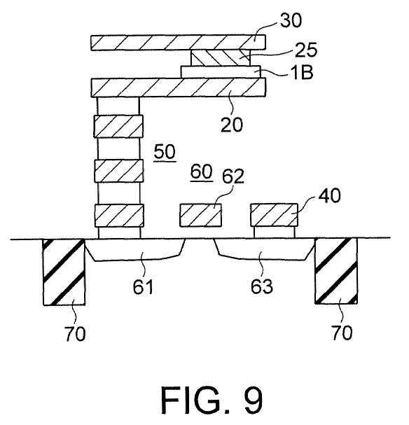

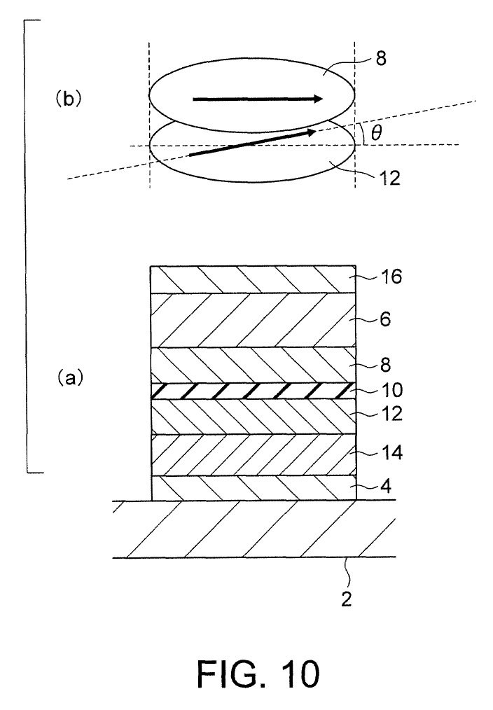

A magnetic memory according to a modification of the present embodiment is shown in FIG. 9. The magnetic memory according to this modification has a configuration obtained by replacing the bottom pin type magnetoresistive effect element 1 in the magnetic memory shown in FIG. 7 with a top pin type magnetoresistive effect element 1A according to the first modification of the first embodiment shown in FIG. 4. The configuration of the magnetoresistive effect element 1A in the magnetic memory according to the present modification is shown in FIG. 10(a). The relation between the direction of magnetization (spin moment) in the magnetization pinned layer 8 and the direction of magnetization in the magnetic recording layer (magnetization free layer) 12 is shown in FIG. 10(b). In this magnetoresistive effect element 1A, the direction of magnetization (spin moment) in the magnetization pinned layer 8 and the direction of magnetization in the magnetic recording layer (magnetization free layer) 12 form a predetermined angle θ which is greater than 0 degree and which is less than 45 degrees as shown in FIG. 10(b). In the same way as the second embodiment, therefore, it becomes possible to make the spin inversion efficiency large. Furthermore, since the magnetoresistive effect element 1A according to the first modification of the first embodiment is used, the thermal stability can be improved in the same way as the first modification of the first embodiment.

In the present embodiment or its modification, the magnetoresistive effect element 1 according to the first embodiment shown in FIG. 1 or the magnetoresistive effect element 1A according to the first modification shown in FIG. 4 is used as a storage element. Even if the magnetoresistive effect element 1B according to the second modification shown in FIG. 5 or the magnetoresistive effect element 1C according to the third modification shown in FIG. 6 is used, however, similar effects can be obtained.

### Third Embodiment

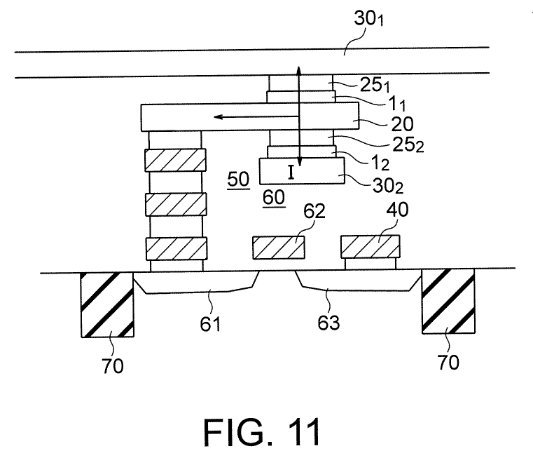

A magnetic memory according to a third embodiment of the present invention is shown in FIG. 11. The magnetic memory according to this embodiment includes at least one memory cell. This memory cell is provided in an intersection region of bit lines 30₁ and 30₂ and a word line 40. The memory cell includes bottom pin type magnetoresistive effect elements 1₁ and 1₂ according to the first embodiment shown in FIG. 1 and a selection transistor 60 for both writing and reading, and forms one bit. The selection transistor 60 includes a source region 61, a gate 62 and a drain region 63. One of terminals of the magnetoresistive effect element 1₁ is connected to a extraction electrode 20, and the other of the terminals is connected to the bit line 30₁ via a metal hard mask or via 25₁. The extraction electrode 20 is connected to the source region 61 of the selection transistor 60 via a connection part 50. The word line 40 is connected to the drain region 63 of the selection transistor 60. The selection transistor 60 is formed in an element region of a semiconductor substrate isolated by an element isolation region formed of an insulation film. The magnetoresistive effect element 1₂ is provided over a face of the extraction electrode 20 opposite to the face on which the magnetoresistive effect element 1₁ is provided. One of its terminals is connected to the extraction electrode 20 via a metal hard mask or a via 25₂. The other of the terminals is connected to the bit line 30₂. The magnetoresistive effect element 1₂ is formed so as to have, in a direction directed from the extraction electrode 20 toward the bit line 30₂, a layer arrangement (stacking order) obtained by inverting a layer arrangement (stacking order) in the magnetoresistive effect element 1₁ in the direction directed from the extraction electrode 20 toward the bit line 30₁. For example, if the magnetoresistive effect element 1₁ has a configuration that the magnetization pinned layer 8 is formed on the extraction electrode 20 side and the magnetization free layer (magnetic recording layer) 12 is formed on the bit line 30₁ side, the magnetoresistive effect element 1₂ has a configuration that the magnetization free layer 12 is formed on the extraction electrode 20 side and the magnetization pinned layer 8 is formed on the bit line 30₂ side. Although not illustrated, the bit line 30₂ is changed in direction and disposed so as to be parallel to the bit line 30₁. The bit lines 30₁ and 30₂ are connected to a differential amplifier which is not illustrated.

Owing to such a configuration, differential readout from the magnetoresistive effect elements 1₁ and 1₂ disposed above and below the extraction electrode 20 becomes possible. As a result, the readout speed can be made high.

In the magnetic memory according to the present embodiment as well, it becomes possible to make the spin inversion efficiency large and improve the thermal stability in the same way as the magnetic memory according to the second embodiment.

In the present embodiment, the magnetoresistive effect element 1 according to the first embodiment shown in FIG. 1 is used as a storage element. Even if the magnetoresistive effect element 1A according to the first modification shown in FIG. 4, the magnetoresistive effect element 1B according to the second modification shown in FIG. 5, or the magnetoresistive effect element 1C according to the third modification shown in FIG. 6 is used, however, similar effects can be obtained.

The magnetic memory according to the second or third embodiment further includes a sense current control circuit for controlling a sense current let flow through the magnetoresistive effect element, a driver and a sinker to read out information stored in the magnetoresistive effect element.

### Fourth Embodiment

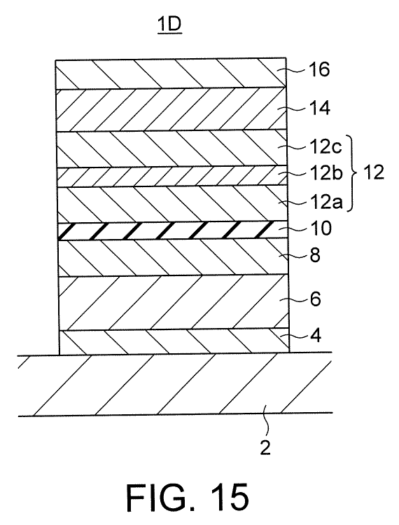

A magnetoresistive effect element according to a fourth embodiment of the present invention is shown in FIG. 15. A magnetoresistive effect element 1D according to the present embodiment has a configuration obtained by replacing the magnetization free layer 12 formed of a single ferromagnetic layer and included in the magnetoresistive effect element 1 according to the first embodiment with a magnetization free layer 12 formed of a ferromagnetic layer 12a, a nonmagnetic layer 12b, and a ferromagnetic layer 12c and having a SAF (Synthetic Anti Ferromagnetic) structure. In other words, the ferromagnetic layer 12a and the ferromagnetic layer 12c are antiferromagnetic-coupled via the nonmagnetic layer 12b.

As the material of the ferromagnetic layer 12a, CoFeB is used. As the material of the nonmagnetic layer 12b, Ru, Ir or Rh is used. As the material of the ferromagnetic layer 12c, NiFe or CoFeB is used. If CoFeB is used as the material of the ferromagnetic layer 12c, it is desirable to insert a Permalloy layer between the ferromagnetic layer 12c and the antiferromagnetic layer 14.

In the present embodiment, the magnetization free layer 12 has the SAF structure laminated in the order of the first ferromagnetic layer/the nonmagnetic layer/the second ferromagnetic layer from the tunnel barrier layer side. However, the magnetization free layer 12 may have the SAF structure laminated in the order of a first ferromagnetic layer/a first nonmagnetic layer/a second ferromagnetic layer/a second nonmagnetic layer/a third ferromagnetic layer. In this case, the first and second ferromagnetic layers are formed of CoFeB, and NiFe or CoFeB is used as the third ferromagnetic layer adjacent to the antiferromagnetic layer 14. If CoFeB is used as the material of the third ferromagnetic layer, it is desirable to insert a Permalloy layer between the third ferromagnetic layer and the antiferromagnetic layer 14.

In the magnetoresistive effect element according to the present embodiment as well, the thermal stability is improved even if the structure is made fine and magnetization in the magnetization free layer can be inverted at a low current density, in the same way as the first embodiment.

As in the present embodiment, the magnetization free layer 12 having the SAF structure can be applied to the magnetoresistive effect elements according to the first to third modifications of the first embodiment shown in FIGS. 4 to 6.

### EXAMPLES

Embodiments of the present invention will now be described in more detail with reference to examples.

### First Example

First, as a first example of the present invention, the magnetoresistive effect element 1B or 1C shown in FIG. 5 or FIG. 6 is fabricated. The manufacturing procedure of magnetoresistive effect element is described hereinafter.

First, as a sample 1, a lower electrode 2/an underlying layer 4 is formed on a substrate (not illustrated) as shown in FIG. 5. A stacked film formed of the antiferromagnetic layer 6/the magnetic layer 8a/the nonmagnetic layer 8b/the magnetic layer 8c/the tunnel barrier layer 10/the magnetic layer 12/the antiferromagnetic layer 14/the cap layer 16 made of Ru/a hard mask is formed as a TMR film. The magnetoresistive effect element 1B is produced by conducting patterning.

As a sample 2, a lower electrode 2/an underlying layer 4 is formed on a substrate (not illustrated) as shown in FIG. 6. A stacked film formed of the antiferromagnetic layer 14/the magnetic layer 12/the tunnel barrier layer 10/the magnetic layer 8c/the nonmagnetic layer 8b/the magnetic layer 8a/the antiferromagnetic layer 6/the cap layer 16 made of Ru/a hard mask is formed as a TMR film. The magnetoresistive effect element IC is produced by conducting patterning.

In the sample 1 and the sample 2 in the present example, Ta/Cu/Ta are used as the lower wiring and Ru is used as the underlying layer. As the TMR film in the sample 1, PtMn (15 nm)/CoFe (3 nm)/Ru (0.9 nm)/CoFeB (4 nm)/MgO (1.0 nm)/CoFeB (3 nm)/FeMn (5 nm) is used in the order from the bottom. As the TMR film in the sample 2, FeMn (6 nm)/CoFeB (3 nm)/MgO (1.0 nm)/CoFeB (4 nm)/Ru (0.9 nm)/CoFeB (3 nm)/IrMn (10 nm) is used. The numeral in ( ) indicates the film thickness. Thereafter, annealing is conducted on each of the sample 1 and the sample 2 in a magnetic field at 360° C. Thereafter, a sample having approximately 20 degrees as an angle formed by the magnetization direction in the magnetic layer serving as the magnetization pinned layer and the magnetization direction in the magnetization free layer, and a sample having 0 degree as the angle are produced at 210° C. in cooling. The element size has a junction size of 0.1×0.2 μm² as a result of fine working.

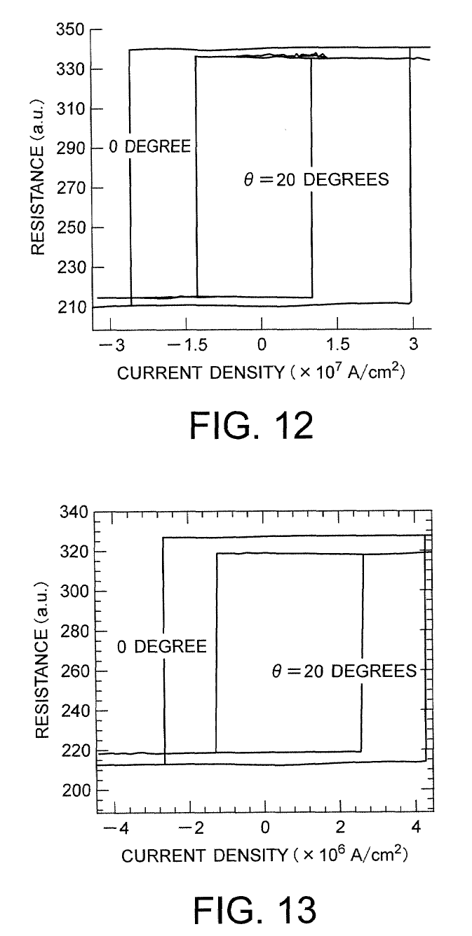

FIG. 12 shows results of measurement of magnetization inversion in the sample 1 caused by spin injection when the tilt angle θ is 0 degree and 20 degrees. FIG. 13 shows results of measurement of magnetization inversion in the sample 2 caused by spin injection when the tilt angle θ is 0 degree and 20 degrees. As shown in FIGS. 12 and 13, it is appreciated that the current density for spin inversion is remarkably reduced in the sample tilted with θ=20 degrees. This fact is expected from the graph shown in FIG. 3. If the tilt angle θ is greater than 0 degree and which is 45 degrees or less, the current density for spin inversion is decreased and the current density at the time of writing is reduced. As a result, the tunnel insulation film 10 is prevented from being destroyed.

### Second Example

As a second example of the present invention, the magnetoresistive effect element 1B shown in FIG. 5 with the materials of the antiferromagnetic layer 6 and the antiferromagnetic layer 14 changed is produced. The producing method for the magnetoresistive effect element 1B is basically the same as the first example.

First, as samples 3 and 4, a lower electrode 2/an underlying layer 4 is formed on a substrate (not illustrated) as shown in FIG. 5. A stacked film formed of the antiferromagnetic layer 6/the magnetic layer 8a/the nonmagnetic layer 8b/the magnetic layer 8c/the tunnel barrier layer 10/the magnetic layer 12/the antiferromagnetic layer 14/the cap layer 16 made of Ru/a hard mask is formed as a TMR film. The magnetoresistive effect element 1B is produced by conducting patterning. In the sample 3 and the sample 4 in the present example, Ta/Cu/Ta are used as the lower wiring and Ru is used as the underlying layer. As the TMR film in the sample 3, PtMn (15 nm)/CoFe (3 nm)/Ru (0.9 nm)/CoFeB (4 nm)/MgO (1.0 nm)/CoFeB (2.5 nm)/FeMn (5 nm) is used in the order from the bottom. As the TMR film in the sample 4, PtMn (15 nm)/CoFe (3 nm)/Ru (0.9 nm)/CoFeB (4 nm)/MgO (1.0 nm)/CoFeB (2.5 nm)/IrMn (5 nm) is used. Thereafter, annealing is conducted on the samples in a magnetic field at 360° C. Thereafter, a sample tilted in angle by approximately 0 to 45 degrees and a sample not tilted are produced at 210° C. in cooling for the sample 3 and at 275° C. in cooling for the sample 4. The element size has a junction size of 0.1×0.2 μm² as a result of fine working.

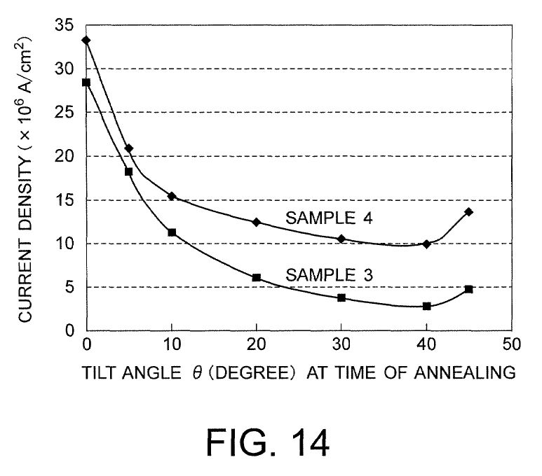

FIG. 14 shows results of measurement of magnetization inversion in the sample 3 and the sample 4 caused by spin injection when θ is changed. The abscissa in FIG. 14 indicates the angle θ formed by the magnetization direction in the magnetization pinned layer 8 and the magnetization direction in the magnetization free layer 12. The ordinate indicates the current density for spin inversion. As appreciated from FIG. 14, the current density for spin inversion is remarkably reduced in both the sample 3 and the sample 4 tilted in θ. It is found that the current density for spin inversion is reduced in the sample 3 using FeMn as the antiferromagnetic layer 14 adjacent to the magnetization free layer 12 as compared with the sample 4 using IrMn as the antiferromagnetic layer 14. It is also found that if the tilt angle θ (degree) becomes greater than 0 the current density decreases because of rapid spin inversion and when 0<θ≦45 the current density at the time of writing is reduced. As a result, the tunnel insulation film 10 can be prevented from being destroyed.

In the second example, PtMn having a film thickness of 15 nm is used as the antiferromagnetic layer 6 in the sample 3 and sample 4, FeMn having a film thickness of 5 nm is used as the antiferromagnetic layer 14 in the sample 3, and IrMn having a film thickness of 5 nm is used as the antiferromagnetic layer 14 in the sample 4. Alternatively, it is also possible to use IrMn having a film thickness of 10 nm as the antiferromagnetic layer 6 and use IrMn having a film thickness of 5 nm as the antiferromagnetic layer 14.

Heretofore, embodiments of the present invention have been described with reference to concrete examples. However, the present invention is not limited to these concrete examples. For example, concrete materials of the ferromagnetic substance layer, insulation film, antiferromagnetic substance layer, non-magnetic metal layer and electrode included in the magnetoresistive effect element, and the layer thickness, shape and dimension that can be suitably selected by those skilled in the art to execute the present invention and obtain similar effects are also incorporated in the scope of the present invention.

In the same way, the structure, material quality, shape and dimension of elements included in the magnetic memory of the present invention that can be suitably selected by those skilled in the art to execute the present invention in the same way and obtain similar effects are also incorporated in the scope of the present invention.

All magnetic memories that can be suitably changed in design and executed by those skilled in the art on the basis of the magnetic memories described above as embodiments of the present invention also belong to the scope of the present invention in the same way.

According to the embodiments of the present invention, a magnetoresistive effect element and a magnetic memory having thermal stability and a favorable spin injection efficiency can be provided as heretofore described in detail, a great deal of merits being brought about. Furthermore, it becomes possible to conduct spin inversion at a low current density and prevent the tunnel insulation film from being destroyed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A magnetoresistive effect element comprising:
a magnetization pinned layer having a magnetization pinned in a direction;
a magnetization free layer of which magnetization direction is changeable by injecting spin-polarized electrons into the magnetization free layer;
a tunnel barrier layer provided between the magnetization pinned layer and the magnetization free layer;
a first antiferromagnetic layer provided on the opposite side of the magnetization pinned layer from the tunnel barrier layer; and
a second antiferromagnetic layer which is provided on the opposite side of the magnetization free layer from the tunnel barrier layer and which is thinner in thickness than the first antiferromagnetic layer.

2. The magnetoresistive effect element according to claim 1, wherein the magnetization pinned layer is a stacked film having a first magnetic layer/a nonmagnetic layer/a second magnetic layer.

3. The magnetoresistive effect element according to claim 1, wherein an easy axis of the magnetization in the magnetization pinned layer and an easy axis of the magnetization in the magnetization free layer form an angle which is greater than 0 degree and which is 45 degrees or less.

4. The magnetoresistive effect element according to claim 1, wherein the first antiferromagnetic layer is NiMn, PtMn or IrMn and the second antiferromagnetic layer is FeMn, IrMn or PtMn.

5. The magnetoresistive effect element according to claim 1, wherein the magnetization free layer is a stacked film having a first magnetic layer/a nonmagnetic layer/a second magnetic layer, or a stacked film having a first magnetic layer/a first nonmagnetic layer/a second magnetic layer/a second nonmagnetic layer/a third magnetic layer.

6. The magnetoresistive effect element according to claim 5, wherein the magnetization free layer is a stacked film having a CoFeB layer/a nonmagnetic layer/a NiFe layer, stacked in this order from the tunnel barrier layer side, or a stacked film having a CoFeB layer/a nonmagnetic layer/a CoFeB layer/a nonmagnetic layer/a NiFe layer, stacked in this order.

7. The magnetoresistive effect element according to claim 5, wherein the magnetization free layer is a stacked film having a CoFeB layer/a nonmagnetic layer/a CoFeB layer, stacked in this order from the tunnel barrier layer side, or a stacked film having a CoFeB layer/a nonmagnetic layer/a CoFeB layer/a nonmagnetic layer/a CoFeB layer, stacked in this order, and a Permalloy layer is provided between the magnetization free layer and the second antiferromagnetic layer.

8. A magnetic memory comprising:
a memory cell comprising the magnetoresistive effect element according to claim 1;
a first wiring to which one of ends of the magnetoresistive effect element is electrically connected; and
a second wiring to which the other of the ends of the magnetoresistive effect element is electrically connected.

9. The magnetic memory cell according to claim 8, wherein the memory cell comprises a MOS transistor connected at either a source or drain thereof to the first wiring.

10. A magnetic memory comprising:
a memory cell comprising first and second magnetoresistive effect elements according to claim 1;
a first wiring connected electrically to first ends of the first and second magnetoresistive effect elements;
a second wiring connected electrically to a second end of the first magnetoresistive effect element; and
a third wiring connected electrically to a second end of the second magnetoresistive effect element,
wherein a layer arrangement of the first magnetoresistive effect element in a direction directed from the first wiring to the second wiring is reverse of a layer arrangement of the second magnetoresistive effect element in a direction directed from the first wiring to the third wiring.

11. The magnetic memory cell according to claim 10, wherein the memory cell comprises a MOS transistor connected at either a source or drain thereof to the first wiring.
